(19) United States
(12) Patent Application Publication
(10) Pub. No.: US 2012/0042067 A1
(43) Pub. Date: Feb. 16, 2012

(54) METHOD AND SYSTEM FOR IDENTIFYING APPLICATIONS ACCESSING HTTP BASED CONTENT IN IP DATA NETWORKS

(75) Inventors: Pablo GERSTENFELD, Montreal (CA); Jean-Philippe GOYET, Montreal (CA); Eric MELIN, Montreal (CA); Olivier MIRANDETTE, Montreal (CA)

(73) Assignee: NEURALITIC SYSTEMS, Montreal (CA)

(21) Appl. No.: 13/208,389

(22) Filed: Sep. 9, 2011

Related U.S. Application Data
(60) Provisional application No. 61/373,492, filed on Aug. 13, 2010.

(51) Int. Cl. G06F 15/173

(52) U.S. Cl. 709/224

(57) ABSTRACT

The present relates to a method and a system for identifying applications accessing HTTP (Hyper Text Transfer Protocol) based content in IP data networks. The method and system collects, by means of at least one collecting entity, real time data from IP data traffic occurring in an IP data network. The method and system extracts information from the collected real time data, the information comprising parameters related to an application accessing HTTP based content in the IP data network. And, the method and system transmits the information from the at least one collecting entity to an analytic system. The method and system further processes the information, at the analytic system. The processing comprises: analyzing the parameters related to an application accessing HTTP based content to identify the application.

### BRIEF DESCRIPTION OF THE DRAWINGS

In the appended drawings:

FIG. 1 illustrates a system for identifying applications accessing HTTP based content in IP data networks, according to a non-restrictive illustrative embodiment;

FIG. 2 illustrates a method for identifying applications accessing HTTP based content in IP data networks, according to a non-restrictive illustrative embodiment;

FIG. 3 illustrates examples of an identification via a user agent request header field of applications accessing HTTP based content, according to a non-restrictive illustrative embodiment.

### DETAILED DESCRIPTION

Nowadays, the variety of applications available on an IP data network has increased dramatically. This is particularly true in the context of mobile IP networks, with the availability of multiple application stores, targeting for instance a specific mobile device manufacturer or a specific operating system. Currently, up to hundreds of thousands of mobile applications may be available on a single application store.

One category of applications consists in applications allowing access to Hyper Text Transfer Protocol (HTTP) based content. Traditionally, web browsers have been used for the purpose of accessing HTTP based content. However, an increasing number of specific applications, which are not a web browser, access HTTP based content via an IP data network. This specific type of applications is generating a significant part of the data traffic on an IP data network.

At the same time, it is becoming increasingly important for a network Operator to have the capability to monitor and analyze the usage of the IP data services consumed via its IP based network infrastructure. Having detailed information related to the IP data traffic generated on its IP based network infrastructure enables a network Operator to adjust its offerings, in terms of devices, data plans, IP data services, and network capacity.

One issue of particular importance in this context is the identification of an application generating a specific IP flow. Having for instance a specific HTTP based IP flow, there is currently no way of identifying the application associated to this specific HTTP based IP flow, since potentially thousands and thousands of different applications may have generated this specific HTTP based IP flow.

Thus, there is a need of overcoming the above discussed limitations, concerning the identification of an application associated to an HTTP based IP flow. An object of the present method and system is therefore to identify applications accessing HTTP based content in IP data networks.

In a general embodiment, the present method is adapted for identifying applications accessing HTTP based content in IP data networks. For doing so, the method collects, by means of at least one collecting entity, real time data from IP data traffic occurring in an IP data network. The method extracts information from the collected real time data; the information comprising parameters related to an application accessing HTTP based content in the IP data network. And the method transmits the information from the at least one collecting entity to an analytic system. The method further processes the information, at the analytic system. The processing comprises: analyzing the parameters related to an application accessing HTTP based content to identify the application.

In another general embodiment, the present system is adapted for identifying applications accessing HTTP based content in IP data networks. For doing so, the system comprises at least one collecting entity for collecting real time data from IP data traffic occurring in an IP data network, for extracting information from the collected real time data—the information comprising parameters related to an application accessing HTTP based content in the IP data network, and for transmitting the information from the at least one collecting entity to an analytic system. The system also comprises an analytic system for processing the information—the processing comprising analyzing the parameters related to an application accessing HTTP based content to identify the application.

In one specific aspect of the present method and system, the parameters related to an application accessing HTTP based content include a user agent request header field of an HTTP request.

In another specific aspect of the present method and system, analyzing the parameters related to an application accessing HTTP based content includes parsing the user agent request header field of an HTTP request to extract the application name.

In still another specific aspect of the present method and system, the parsing of the user agent request header field of an HTTP request, to extract the application name, is performed against at least one identifying pattern type; each of the at least one identifying pattern type defining a lexical representation of the application name in the user agent request header field.

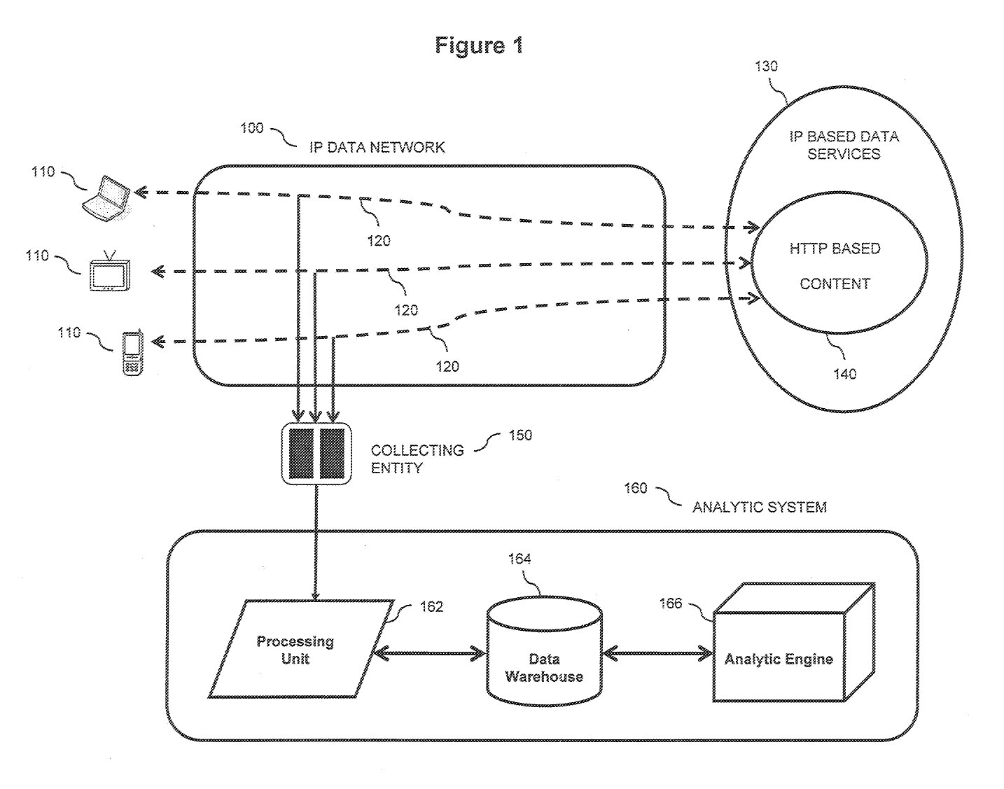

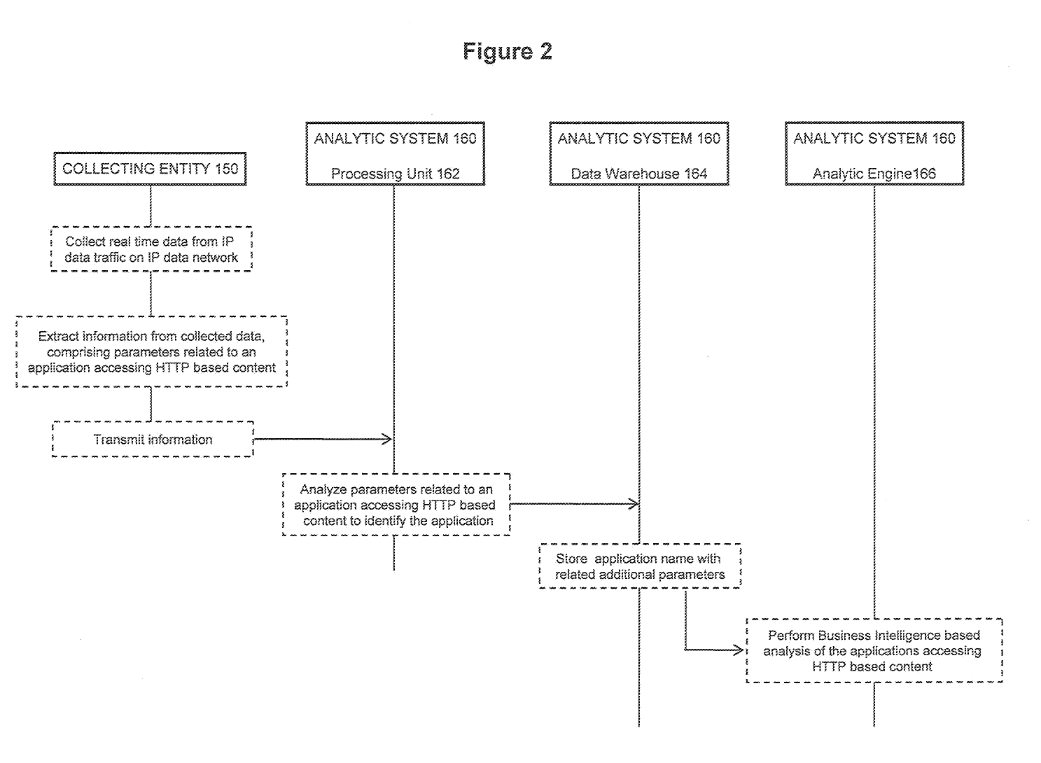

Now referring concurrently to FIGS. 1 and 2, a method and system for identifying applications accessing HTTP based content in IP data networks will be described.

The following definition applies to the present method and system: an application accessing HTTP based content is any type of application, different from a web browser, accessing an HTTP based content, by means of at least one HTTP based IP flow between a device (where the application is executed) and the targeted HTTP content. The notion of web browser is well known in the art, and is interpreted with its usual meaning.

The usual definition of an IP flow is considered in the present method and system: an IP flow is defined by a source IP address and source port, a destination IP address and destination port, and a transport protocol (in most cases, Transmission Control Protocol (TCP) or User Datagram Protocol (UDP)). Thus, an HTTP based IP flow consists in an IP flow as defined previously, wherein the applicative protocol is the HTTP protocol (the transport protocol is the TCP protocol in this case).

An IP data network 100 is represented in FIG. 1. The IP data network 100 may consist in any type of mobile IP network operated by a mobile network Operator, including without limitations: General Packet Radio Service (GPRS) networks, Universal Mobile Telecommunications System (UMTS) networks, Long Term Evolution (LTE) networks, Code Division Multiple Access (CDMA) networks, or Worldwide Interoperability for Microwave Access (WIMAX) networks.

The IP data network 100 may also consist in any type of IP based fixed broadband network operated by an Internet Service Provider (ISP), including without limitations: Digital Subscriber Line (DSL) networks, cable networks, or optical fiber networks.

The IP data network 100 may additionally consist in an IP data network operated by a corporation, for instance a private company or a governmental/public organization.

Various types of devices 110 may be used, to access IP based data services 130 via the IP data network 100. Such devices 110 include computers in their broad sense (desktops, laptops, netbooks, etc), television sets, mobile devices in their broad sense (feature phones, smart phones, tablets, etc). Based on the type of IP data network 100, only a subset of the previously mentioned types of devices 110 may be used. However, due to the convergence of the IP data networks 100 (specifically fixed and mobile convergence), more and more types of devices 110 may be used to seamlessly access various types of IP data networks 100.

Consuming an IP based data service 130 usually consists in having an application execute on a device 110; wherein the application generates one (or several) IP flow(s) on the IP data network 100, to interact with the IP based data service 130. Usual types of IP based data services 130 include, among others: web browsing, emailing, instant messaging, audio and video streaming, Voice over IP, Peer to Peer, etc.

In the context of the present method and system, we consider a specific type of applications used on the devices 110. These applications access a specific type of IP based data services 130: services which deliver HTTP based content 140. Thus, the interactions between such an application on a mobile device 110, and the HTTP based content 140, generate specific IP flows 120, namely HTTP based IP flows (IP flows for which the applicative layer is the HTTP protocol).

The HTTP based content 140 refers to any type of data content, which is used by a specific type of application (executed on a device 110) to operate properly. This HTTP based content 140 is usually hosted on a (several redundant) server(s), and concurrently accessed by a multitude of instances of the specific type of application executed on various devices 110. Other types of applicative protocols (than the HTTP protocol) may be used to access this content 140 (including proprietary protocols developed exclusively for a specific type of application). However, the HTTP protocol has several properties which make it a preferred choice for accessing a remote content 140. For instance, the HTTP protocol is well normalized. It is also reasonably easy to use, when developing an application which needs to access a remote content 140, via an IP data network 100. Additionally, the HTTP protocol is very resilient in terms of network infrastructure traversal (for example, it easily traverses firewalls and Network Address Translators). For these reasons, a large number of applications (different from web browsers) use the HTTP protocol to access a remote content 140; referred to as an HTTP based content 140 in the present method and system, since it is accessed via the HTTP protocol. The HTTP based content 140 may be hosted as a traditional web site on a web server; or on a generic server accessible via the HTTP protocol in a standard client (the device 110)/server architecture.

A collecting entity 150 collects data, by capturing in real time IP packets from the IP data traffic occurring on a segment of the IP data network 100. The captured IP packets contain data related to IP data sessions occurring on the IP data network 100. An IP data session is defined as an IP based data session initiated by a device 110 on the IP data network 100, during which the device 110 consumes various types of IP based data services 130 (for example messaging, web browsing, social networking, multimedia streaming, etc), including access to HTTP based content 140. The IP packets related to a specific IP data session are analyzed according to the protocol layers of the Open System Interconnection (OSI) model, to extract parameters representative of the IP data traffic on the IP data network 100. This technique is well known in the art as Deep Packet Inspection (DPI). And the type of parameters which are extracted from IP packets by a DPI based collecting entity 150 is also well known in the art.

Usually, a collecting entity 150 collects data in real time for various purposes. Thus, the information extracted from the collected data for the specific purpose of identifying applications accessing HTTP based content 140 may represent a fraction of the global information gathered by the collecting entity 150. Thus, the HTTP based IP flows 120 are identified by the DPI engine of the collecting entity 150. And specific information, relative to these HTTP based IP flows 120, is extracted from the data collected by the collecting entity 150. This specific information consists in parameters related to the applications accessing the HTTP based content 140 via the HTTP based IP flows 120. These parameters are further analyzed, as will be described in the following paragraphs, to identify the applications. A detailed description of these parameters will also be provided in the following paragraphs.

In one exemplary embodiment, where the IP data network 100 is a mobile IP network of the Third Generation Partnership Project (3GPP) family, the collecting entity 150 may be positioned between a Serving GPRS Support Node (SGSN) and a Gateway GPRS Support Node (GGSN), in order to collect the IP data traffic occurring between these two equipments (well known in the art as the GPRS Tunneling Protocol (GTP) control and user planes).

The collecting entity 150 transmits the extracted information to an analytic system 160. The transmitted information contains all the parameters collected by the collecting entity 150 over a pre-defined period of time. In one embodiment of the present method and system, the analytic system 160 is composed of a pre-processing unit 162, a data warehouse 164, and an analytic engine 166.

Based on the type, topology, and size of the IP data network 100, several collecting entities 150 may be deployed at various locations, transmitting their respectively extracted information to a centralized analytic system 160.

The information received from the collecting entity 150 is processed by the processing unit 162 of the analytic system 160. This processing consists in analyzing the parameters related to an application accessing HTTP based content 140, in order to identify this application.

In one exemplary embodiment, for each HTTP based IP flow 120, the collecting entity 150 extracts the user agent request header field of an HTTP request sent from a device 110 to an entity hosting the HTTP based content 140. This information (the user agent request header field) is extracted from the data collected in real time from the HTTP based IP flows 120 by the collecting entity 150. A user agent request header field is a specific header field included in an HTTP request message, as defined per the specifications of the HTTP protocol.

The user agent request header field constitutes a parameter, which is part of the information transmitted by the collecting entity 150 to the analytic system 160. The user agent request header field is composed of a string of alphanumerical characters. Thus, the analysis performed by the processing unit 162 of the analytic system 160 consists in parsing this string, in order to extract the application name. This application name identifies the application generating an HTTP based IP flow 120, to which the user agent request header field in question is related.

The application name in the user agent request header field follows different lexical representations, based on several characteristics of the device 110 where the application is executed: manufacturer and model of the device, operating system of the device, Software Development Kit (SDK) used to develop the application, etc. Thus, a list of identifying pattern types may be used. This list contains the most frequent lexical representations of the application names. Each user agent request header field is analyzed against each identifying pattern types of the list. If a match is found, the application name is extracted from the user agent request header field, according to the matching lexical representation.

The lexical representation may include the exclusion of specific strings. For instance, if a lexical identifier associated to a web browser is present in the user agent request header field, the application associated to the related HTTP based IP flow 120 is a web browser, and is not considered (since web browsers are excluded from the applications targeted by the identification process of the present method and system).

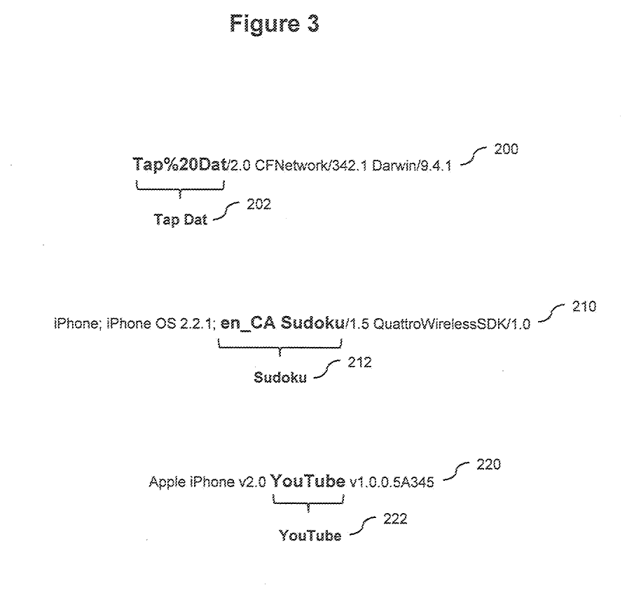

FIG. 3 will further illustrate three examples of such lexical representations of the application names in a user agent request header field.

Additional information related to an application name extracted from a user agent request header field may also be collected (if present and defined by the lexical representation): the version of the application, the type of device where the application is executed (including manufacturer and model if available), the Operating System (OS) of the device, etc.

The collecting entity 150 may extract additional information from the data collected in real time from the IP data network 100. For each HTTP based IP flow 120, in addition to the already mentioned parameters necessary for the identification of the related application, the following additional parameters may be extracted: timestamps (beginning and end) of occurrence of the HTTP based IP flow 120, an identifier (preferably unique) of the device 110 generating the HTTP based IP flow 120, the total volume of IP traffic conveyed by the HTTP based IP flow (possibly differentiating upstream and downstream volume). The unique identifier of a device 110 may be a Media Access Control (MAC) address, an International Mobile Equipment Identity (IMEI), an International Mobile Subscriber Identity (IMSI), a Mobile Subscriber Integrated. Services Digital Network (MSISDN) number, etc—depending on the type of device 110 (computer, mobile device, etc), and the type of IP data network 100 (fixed broadband, mobile, etc). These additional parameters are also transferred to the analytic system 160.

When the processing unit 162 identifies the application associated to an HTTP based IP flow 120, one occurrence of the usage of this application is memorized in the data warehouse 164 (for instance, the name of the application is recorded). The additional parameters previously mentioned (timestamps of occurrence, unique identifier of the device, volume of IP traffic) may also be recorded in the data warehouse 164, to further characterize this instance of an occurrence.

Taking into consideration privacy issues, the unique identifiers (for instance MAC address, IMEI, IMSI, MSISDN, etc) of the devices 110 may not be directly recorded in the data warehouse 164. Instead, a unique computer generated identifier may be used, in place of each original unique identifier, for recording purposes in the data warehouse 164.

The analytic engine 166 performs an analysis of the information stored in the data warehouse 164, to correlate a specific application name with the related parameters (timestamps of occurrences, unique identifiers of the devices using the application, volume of IP traffic generated).

Usually, an analytic engine 166 has Business Intelligence (BI) and/or data mining capabilities, to further process the information extracted from a data warehouse 164, and to generate metrics. Trends and behaviors in the usage of applications accessing HTTP based content 140 via the IP data network 100 are identified via the BI capabilities. Additionally, clusters of users with specific consumption patterns (of the applications accessing HTTP based content 140) are identified via the data mining capabilities.

Examples of metrics, which are generated by the analytic engine 166 for a specific application (identified by its name), consist in: the total number of occurrences of the application over a period of time, the number of unique users using the application over a period of time (a unique user is identified via the unique identifier of the related device 110), the total volume of IP traffic generated by the application over a period of time. Additional parameters may be collected and extracted by the collecting entity 150, in relation to the HTTP based IP flows 120, allowing the generation of additional metrics by the analytic engine 166.

Several different instances of HTTP based IP flows 120 may correspond to a single occurrence of a related application. Additional processing (considered as out of the scope of the present method and system) is performed by the DPI engine of the collecting entity 150, to detect this specific situation; and a single occurrence of the application is accounted for.

The processing unit 162 and the analytic engine 166 are respectively composed of dedicated software programs executed on a dedicated computer. Alternatively, dedicated software programs corresponding to the processing unit 162 and the analytic engine 166 may be executed on the same computer. The implementation of the data warehouse 164 is considered as well known in the art.

Although the collecting entity 150 and the three components (162, 164, and 166) of the analytic system 160 have been described (and represented in FIG. 1) as separate entities, the collecting entity 150 may be integrated with the processing unit 162, and optionally with the data warehouse 164 and/or the analytic engine 166, from an implementation point of view.

Now referring to FIG. 3, examples of an identification via a user agent request header field of applications accessing HTTP based content will be described.

Three user agent request header fields 200, 210, and 220, are represented in FIG. 3. They correspond to a device 110 (FIG. 1) of the mobile device type, more specifically to an iPhone. Thus, the IP data network 100 (FIG. 1) is a mobile IP network, or possibly a WIFI network.

As previously mentioned, the three user agent request header fields 200, 210, and 220, consist in a string of alphanumerical characters, where the name of the application is included, and follows a specific lexical representation.

Three different application names are represented in FIG. 3: Tap Dat 202, Sudoku 212, and YouTube 222. Each application name has a different lexical representation, and the corresponding user agent request header fields have specific pattern types, used by the present method and system to identify the application name.

The first user agent request header field 200 has the following pattern types: it contains the strings “CFNetwork” (identifying a framework in the core services framework of the iPhone Operating System) and “Darwin” (identifying an open source Operating System, which is a basis of the iPhone Operating System). Then, the raw application name is at the beginning of the string, and ends with the character “/”. This corresponds to “Tap%20Dat” in FIG. 3. Finally, the following rules are applied to the raw application name to obtain the application name: each string “%20” within the raw application name is replaced by a space; then each string “%XX” (where X are numbers) is removed. Thus, the application name obtained is “Tap Dat” 202.

The second user agent request header field 210 has the following pattern types: it contains the strings “iPhone” (identifying an iPhone type of mobile device) and “QuattroWirelessSDK” (identifying the Quattro Wireless Software Development Kit (SDK) with which the application has been developed). Then, the raw application name is the string between the second character “;” and the first character “/”. This corresponds to “en_CA Sudoku” in FIG. 3. Finally, the following rule is applied to the raw application name to obtain the application name: the first sub-string (“en_CA” in the example) is the language and is removed. Thus, the application name obtained is “Sudoku” 212.

The third user agent request header field 220 has the following pattern types: it contains the string “AppleiPhone” (identifying an iPhone type of mobile device) and does not contain the string “Safari” (which identifies the web browser Safari, which is a type of application not considered in the present method and system). Then, the raw application name is the string between the string representing the iPhone version (“v2.0” in the example), and the string representing the application version (“v1.0.0.5A345” in the example). This corresponds to “YouTube” in FIG. 3. In this case, the application name is directly the raw application name. Thus, the application name obtained is “YouTube” 222.

In FIG. 3, three pattern types have been defined for applications executed on an iPhone. Additional pattern types may be defined for the iPhone. Then, pattern types may be defined for other types of mobiles devices (corresponding to a specific manufacturer, and optionally to a specific model of mobile device). Pattern types may also be defined for a specific operating system (e.g. Android). Additionally, pattern types may also be defined for devices different from mobile devices: netbooks, tablets, computers, television sets, etc.

A user agent request header field (extracted by the collecting entity 150 in FIG. 1) is analyzed by the processing unit (162 in FIG. 1) against a pre-defined list of pattern types. If a match is found, the application name is extracted, following the syntactic representation of the application name defined by the pattern type.

Although the present method and system have been described in the foregoing specification by means of several non-restrictive illustrative embodiments, these illustrative embodiments can be modified at will without departing from the scope of the following claims.

What is claimed is:

1. A method for identifying applications accessing HTTP (Hyper Text Transfer Protocol) based content in IP data networks, the method comprising:
collecting by means of at least one collecting entity real time data from IP data traffic occurring in an IP data network;
extracting information from said collected real time data, the information comprising parameters related to an application accessing HTTP based content in the IP data network;
transmitting said information from said at least one collecting entity to an analytic system;
processing said information at the analytic system, the processing comprising analyzing the parameters related to an application accessing HTTP based content to identify said application.

2. The method of claim 1, wherein the parameters related to an application accessing HTTP based content include a user agent request header field of an HTTP request.

3. The method of claim 2, wherein analyzing the parameters related to an application accessing HTTP based content includes parsing the user agent request header field of an HTTP request to extract the application name.

4. The method of claim 3, wherein the parsing of the user agent request header field of an HTTP request to extract the application name is performed against at least one identifying pattern type; each said at least one identifying pattern type defining a lexical representation of the application name in the user agent request header field.

5. The method of claim 3, wherein parsing the user agent request header field of an HTTP request further consists in extracting at least one of: the version of the application, the type of device where the application is executed, the OS (Operating System) where the application is executed.

6. The method of claim 3, wherein the parameters related to an application accessing HTTP based content further include at least one of: timestamps of occurrence of the application accessing HTTP based content, a unique identifier of a device where the application accessing HTTP based content is executed, a volume of IP traffic generated by the application accessing HTTP based content.

7. The method of claim 6, wherein processing the information at the analytic system further comprises: correlating at least one of the application names, the timestamps of occurrence, the unique identifiers of the devices, and the volumes of IP traffic generated, in the purpose of performing an analysis of the applications accessing HTTP based content in the IP data network from a Business Intelligence or Data Mining perspective.

8. A system for identifying applications accessing HTTP (Hyper Text Transfer Protocol) based content in IP data networks, the system comprising:
at least one collecting entity:
for collecting real time data from IP data traffic occurring in an IP data network;
for extracting information from said collected real time data, the information comprising parameters related to an application accessing HTTP based content in the IP data network; and
for transmitting said information from said at least one collecting entity to an analytic system;
an analytic system:
for processing said information, the processing comprising analyzing the parameters related to an application accessing HTTP based content to identify said application.

9. The system of claim 8, wherein the parameters related to an application accessing HTTP based content include a user agent request header field of an HTTP request.

10. The system of claim 9, wherein analyzing the parameters related to an application accessing HTTP based content includes parsing the user agent request header field of an HTTP request to extract the application name.

11. The system of claim 10, wherein the parsing of the user agent request header field of an HTTP request to extract the application name is performed against at least one identifying pattern type; each said at least one identifying pattern type defining a lexical representation of the application name in the user agent request header field.

12. The system of claim 10, wherein parsing the user agent request header field of an HTTP request further consists in extracting at least one of: the version of the application, the type of device where the application is executed, the OS (Operating System) where the application is executed.

13. The system of claim 10, wherein the parameters related to an application accessing HTTP based content further include at least one of: timestamps of occurrence of the application accessing HTTP based content, a unique identifier of a device where the application accessing HTTP based content is executed, a volume of IP traffic generated by the application accessing HTTP based content.

14. The system of claim 13, wherein processing the information at the analytic system further comprises: correlating at least one of the application names, the timestamps of occurrence, the unique identifiers of the devices, and the volumes of IP traffic generated, in the purpose of performing an analysis of the applications accessing HTTP based content in the IP data network from a Business Intelligence or Data Mining perspective.
